(19) United States
(12) Patent Application Publication
(10) Pub. No.: US 2001/0024910 A1
(43) Pub. Date: Sep. 27, 2001

(54) Cable connector

(75) Inventors: Kenji Ishii, Tokyo (JP); Kunio Watanabe, Tokyo (JP)

Correspondence Address: BAKER & BOTTS, L.L.P., 30 ROCKEFELLER PLAZA, NEW YORK, NY, 10112, US

(73) Assignee: DDK LTD.

(21) Appl. No.: 09/809,365

(22) Filed: Mar. 15, 2001

(30) Foreign Application Priority Data
Mar. 21, 2000 (JP) 2000-78,240

(51) Int. Cl. H01R 9/05

(52) U.S. Cl. 439/682

(57) ABSTRACT

A cable connector includes a cylindrical shell, a contact holder in the form of an inner bottom plate, and a plurality of contacts supported in the contact holder. The contact holder consists of a front holder and a rear holder which are formed with a plurality of through-holes communicating and aligned with each other for embracing the contacts inserted in the through-hole. With this arrangement, in assembling the cable connector, the contacts can be rapidly supported in the contact holder in a simple manner.

### BACKGROUND OF THE INVENTION

This invention relates to a cable connector including a contact holder which, in assembling the connector, makes it possible to support a plurality of contacts quickly in a simple manner.

In connecting cables to each other or to electronic appliances or the like, various electrical connectors have been proposed as known to those skilled in the art. As a matter of course, contacts are built in such connectors for connecting wires of a cable such as metal wires of a metal cable or optical fibers of an optical cable.

For example, with a connector including a contact holder in the form of an inner bottom plate fitted in a cylindrical shell, the contact holder supporting a plurality of contacts is constructed to be waterproof. In such a case, it has been proposed to use a disc-shaped contact holder 1 made of a rubber having an appropriate hardness and formed with a plurality of through-holes 1a into which metal contacts 2 are press fitted, respectively, as shown in FIG. 6.

With such a press-fitting method, as its construction becomes simple and contact supporting is wieldy, it looks like that a low cost assembling has been accomplished, but this is not the case. In reality, technical problems with this method remain to be solved.

First, with a great number of contacts, the insertion of the contacts into the holder one by one will takes much time, and the insertion of the contacts into their predetermined positions with a high accuracy is unexpectedly difficult and requires a great skill.

It may be possible to insert all of a plurality of contacts 2 into the holder at a time with the aid of a suitable jig or tool. In this case, however, there is a risk of a tendency for the holder made of a rubber to be deformed, so that the contacts are irregularly arranged facing into wrong directions and the required waterproof construction could not be obtained due to the deformation of the rubber holder. Moreover, the irregular arrangement of the contacts causes an important problem making it impossible to obtain the correct connection of the contacts to a mating connector or electronic appliance.

### SUMMARY OF THE INVENTION

It is an object of the invention to provide a cable connector which eliminates all the disadvantages of the prior art described above and which comprises a two-piece contact holder consisting of a front and a rear holder capable of correctly supporting contacts with ease, and, if required, an annular sealing gasket provided at an abutment surface of a rear shell against one end of a cylindrical shell to provide a waterproof construction.

In order to accomplish the above object, in a cable connector including a cylindrical shell, a contact holder in the form of an inner bottom plate fitted in said cylindrical shell, and a plurality of contacts supported in said contact holder, according to the invention said contact holder comprises a front holder and a rear holder which are formed with a plurality of through-holes communicating and aligned with each other for embracing said contacts inserted in the through-holes.

With the cable connector according to the invention, the contacts may be of a male type or a female type.

In one embodiment of the invention, the cable connector comprises a cylindrical rear shell into which one end of the cylindrical shell is fitted, and an annular sealing ring provided at an abutment portion of the one end of the cylindrical shell against the cylindrical rear shell.

The cable connector according to the invention provides the following significant effects.

According to the invention, the contact holder consisting of the front holder and the rear holder which are formed with the aligned through-holes for embracing a plurality of contacts, making it possible to support the contact in a simple and quick manner.

According to the invention, particularly, the inner diameters of the respective parts of the through-holes in the front and rear holders are so sized that the portions of the contacts can be smoothly fitted in the corresponding portions of the through-holes, whereby the contacts can be firmly held by the front and rear holders by simply assembling the contacts and the holders into the connector. Therefore, even with a great number of contacts, they can be assembled into the connector in a short time so that the operation efficiency will be greatly improved. By using a suitable jig or tool, a plurality of contacts can be simultaneously inserted into the through-holes of the front and rear holders at a time in manual operation, even in automatic operation.

With the arrangement according to the invention, no undue loads act on the holders so that no deformations occur in the holders, as a result of which the contacts are correctly supported in their predetermined positions. Accordingly, these operations can be performed without requiring any skilled operator, and any deviation of the positions from the desired parallel positions of the contacts will be eliminated, with the result that the correct connection of the contacts to contacts of a mating connector or an electronic appliance can be achieved.

According to the invention, the annular sealing gasket is provided at the abutment of the one end of the shell against the rear shell to provide a good waterproof construction.

The invention will be more fully understood by referring to the following detailed specification and claims taken in connection with the appended drawings.

### BRIEF DESCRIPTION OF THE DRAWINGS

FIG. 1 is a partly longitudinal sectional side view illustrating a cable connector according to one embodiment of the invention;

FIG. 2 is an enlarged partly longitudinal sectional view of the contact holder and one contact of the cable connector shown in FIG. 1;

FIG. 3 is a partly longitudinal sectional side view illustrating a cable connector according to another embodiment of the invention;

FIG. 4 is an enlarged partly longitudinal sectional view of the contact holder and one contact of the cable connector shown in FIG. 3;

FIG. 5 is a partly longitudinal sectional side view illustrating the cable connectors shown in FIGS. 1 and 3 which have been connected to each other; and

FIG. 6 is a perspective view illustrating the relation between a contact and a contact holder of a connector of the prior art.

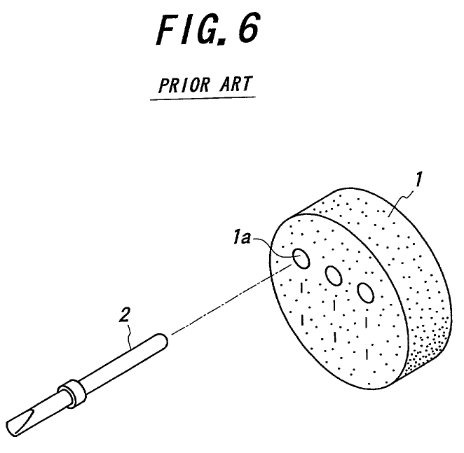

### DESCRIPTION OF THE PREFERRED EMBODIMENTS

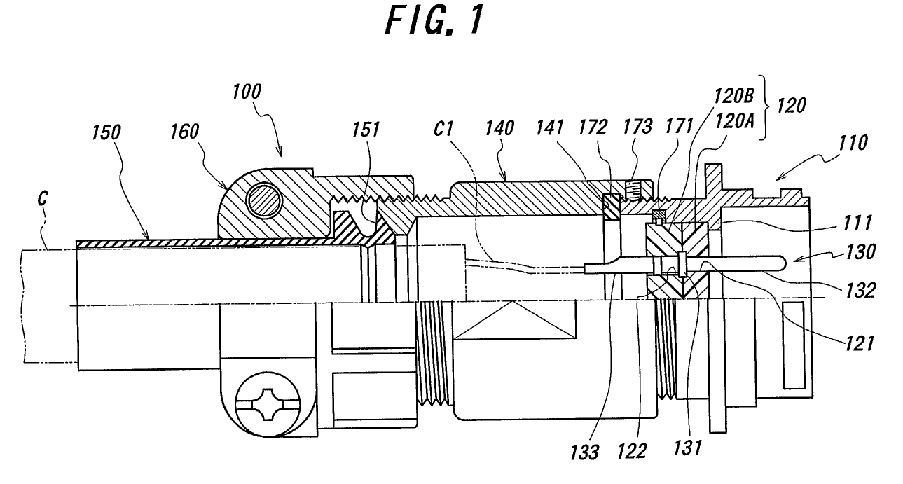

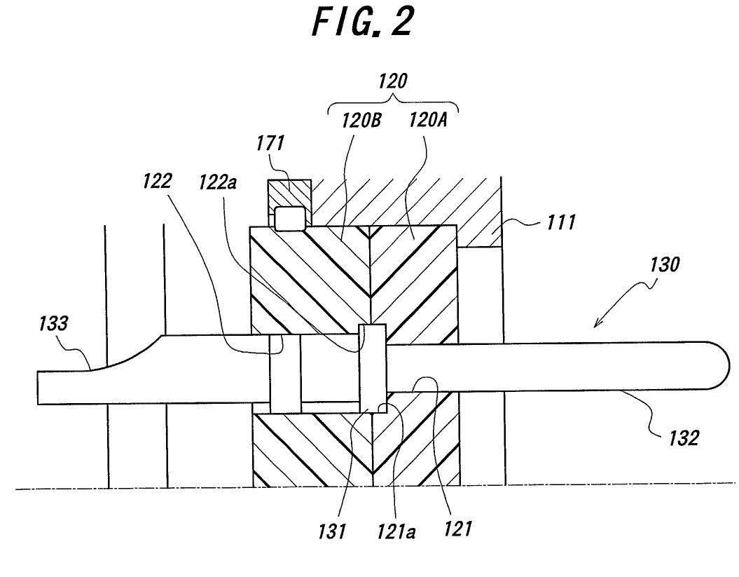

FIGS. 1 and 2 illustrate one embodiment of the cable connector according to the invention, whose contacts in this case are of a male type.

The connector 100 mainly comprises a cylindrical shell 110, a contact holder 120 in the form of an inner bottom plate fitted in the shell 110, a plurality of male contacts (only one being shown in the drawings) 130 supported in the contact holder 120, a cylindrical rear shell 140 fitted on the rear end of the shell 110 (on its left end viewed in FIG. 1), a cylindrical elastic bushing 150 abutting against the rear end of the cylindrical rear shell 140 (on its left end viewed in FIG. 1) and fitted on the outside of a cable C (shown in imaginary lines in FIG. 1), and a cap-shaped cable clamp 160 surrounding the elastic bushing 150 and having internal threads formed in its inside at its front end adapted to be threadedly engaged with the external threads formed on the rear end of the cylindrical rear shell 140.

The contact holder 120 is a two-piece member consisting of a front holder 120A and a rear holder 120B which are formed with a plurality of through-holes 121 and 122 communicating and aligned with each other for inserting the contacts 130 through the through-holes 121 and 122 and firmly holding them therein.

These through-holes 121 and 122 are not constant diameter holes, but have enlarged or reduced diameter portions therein to form shoulders which serve to embrace the contacts 130 as described below, thereby firmly holding the contacts 130.

In more detail, the contact 130 as shown in FIG. 2 comprises a slightly enlarged diameter flange 131 formed substantially at its mid portion, a contact pin 132 forwardly extending from the flange 131 having a smaller diameter, and a connection portion 133 rearward extending from the flange 131 for connecting a wire of the cable C. The front and rear holders 120A and 120B are formed with enlarged diameter hole portions 121a (on the left end of the through-holes 121 viewed in FIG. 2) and 122a (on the right end of the through-holes 122) correspondingly to the shape of the contacts 130.

In the context of the present application, the term “forward” or “forwardly” means the direction in which a connector faces to a mating connector or electronic appliance to be connected with the connector, while the term “rearward” means the direction opposite to the forward direction. In connection therewith, the term “front” or “rear” will be understood in the same manner.

Consequently, in assembling the contacts 130 into the connector 100, the contact pins 132 of the contacts 130 are inserted into the through-holes 121 of the front holder 120A until the flanges 131 of the contacts 130 are completely fitted within the enlarged diameter hole portions 121a of the front holder 120A, and then the rear holder 120B is brought into an abutment against the front holder 120A so that the connection portions 133 of the contacts 130 completely extend through the through-holes 122 of the rear holder 120B. As a result, the flanges 131 are completely embraced in the enlarged diameter hole portions 121a and 122a of the front and rear holders 120A and 120B, thereby firmly holding the contacts 130 in the front and rear holders 120A and 120B. Of course, the respective portions of the through-holes of the front and rear holders 120A and 120B may have inner diameters so sized that the portions of the contacts 130 can be smoothly fitted into the corresponding portions of the through-holes.

The contact and holder subassembly thus assembled is fitted into the rear cylinder portion of the shell 110 so that the front holder 120A is brought into an abutment against a stopper 111 formed by, for example, a reduced diameter portion in the shell 110, while a fixture 171 such as a retainer ring is interposed between the cylindrical outer surface of the rear holder 120B and the inner wall of the shell 110, thereby enabling the contact holder 120 to be fixed in a simple manner. Alternatively, instead of the stopper 111, simple protrusions (not shown) serving as positioning means may be used. In this manner, the contacts 130 can be correctly supported in their predetermined positions. Wires C1 of the cable C are connected to the connection portions 133 of the contacts 130, respectively.

The front and rear holders 120A and 120B performing the above functions may be formed of an insulating material such as a resin. Different from the prior art, according to the invention the contacts 130 are fixed to the holders 120A and 120B without using press-fitting, the holders are subjected to slight load only, making it possible to form the holders from a rubber having a suitable hardness.

In fitting the shell 110 with its rear end in the rear shell 140, according to the invention as shown in FIG. 1 an annular sealing gasket 172 is provided between the rear end of the shell 110 and the shoulder 141 of an enlarged inner diameter portion of the rear shell 140 to provide a waterproof construction for effectively preventing any water from entering at the outer peripheries of these shells 110 and 140. Moreover, the elastic bushing 150 arranged about the outer surface of the cable C has an enlarged diameter portion 151 at its front end which abuts against the rear end of the rear shell 140 also to provide a waterproof construction for effectively preventing any water from entering from the side of the cable C.

The shell 110 and the rear shell 140 are connected to each other at their fitting portions by means of connecting means such as screws formed in their abutting surfaces. In order to ensure a more reliable connection therebetween, according to the invention set screws 173 are provided so as to be engaged with both the shells 110 and 140. However, these set screws 173 may be dispensed with, if desired.

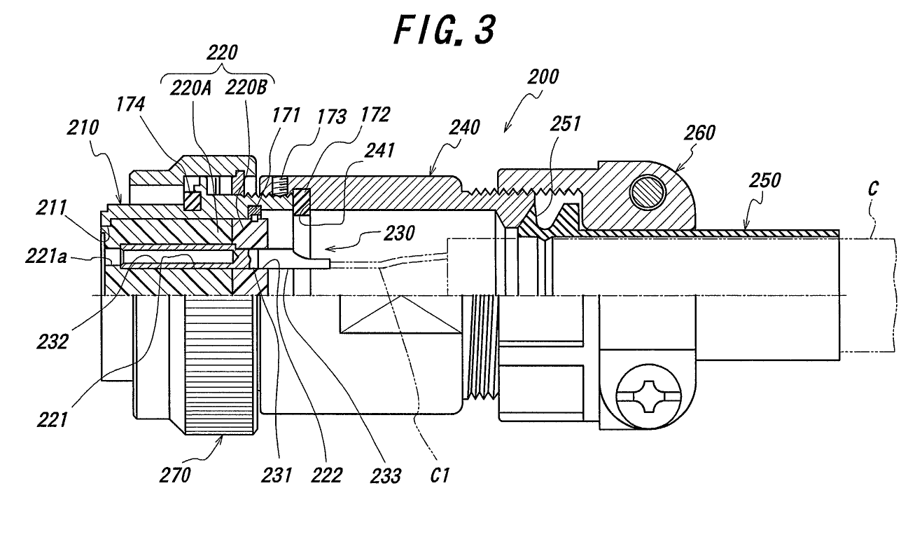

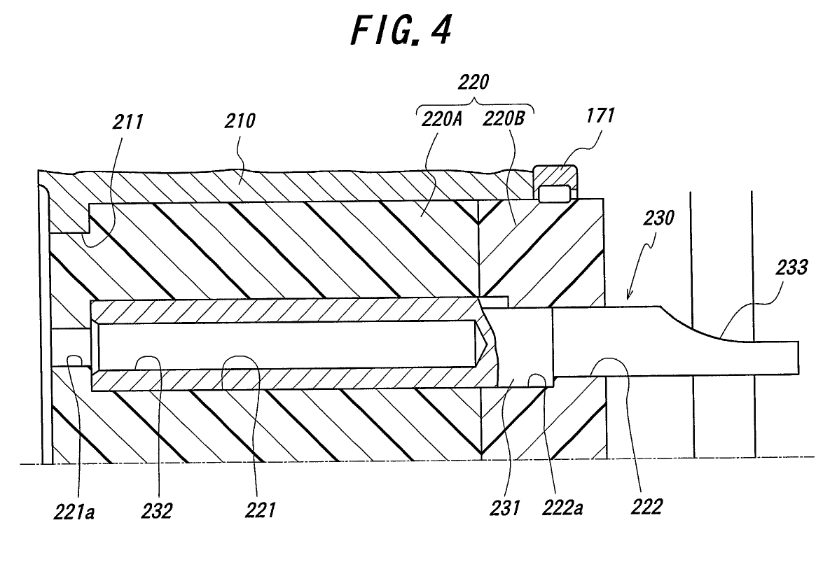

FIGS. 3 and 4 illustrate another embodiment of the cable connector according to the invention, whose contacts in this case are of a female type.

The connector 200 also mainly comprises, similarly to the connector 100, a cylindrical shell 210, a contact holder 220 in the form of an inner bottom plate fitted in the shell 210, a plurality of a female contacts (only one being shown in FIG. 3) 230 supported in the contact holder 220, a cylindrical rear shell 240 fitted on the rear end of the shell 210 (on its right end viewed in FIG. 3), a cylindrical elastic bushing 250 abutting against the rear end of the cylindrical rear shell 240 (on its right end viewed in FIG. 3) and fitted on the outside of a cable C (shown in imaginary lines in FIG. 3), a cap-shaped cable clamp 260 surrounding the elastic bushing 250 and having internal threads formed in its inside at its front end adapted to be threadedly engaged with the external threads formed on the rear end of the cylindrical rear shell 240, and a cylindrical coupling 270 adapted to be fitted on the shell 210 for engaging a mating connector, for example, the outside of the shell 110 of the connector 100 shown in FIGS. 1 and 2 in order to connect the connectors 100 and 200.

The contact holder 220 is a two-piece member consisting of a front holder 220A and a rear holder 220B which are formed with a plurality of through-holes 221 and 222 communicating and aligned with each other for inserting the contacts 230 through the through-holes 221 and 222 and firmly holding them therein.

These through-holes 221 and 222 are not constant diameter holes, but have enlarged or reduced diameter portions therein to form shoulders which serve to embrace the contacts 230 as described below, thereby firmly holding the contacts 230.

In more detail, the contact 230 as shown in FIG. 4 comprises a pipe portion 231 having a contact hole 232 extending from the front end of the contact over a distance in excess of one half of the entire length of the contact, and a connection portion 233 having a slightly reduced diameter and rearward extending from the pipe portion for connecting a wire of the cable. Correspondingly to the shape of the contacts 230, the front holder 220A formed with reduced diameter holes 221a at its front end (on the left end of the through-holes 221 viewed in FIG. 4), which communicate with and smaller than the through-holes 221, while the rear holder 220B is formed with enlarged diameter holes 222a at its end adjacent the front holder 220A (on the left end of the through-holes 222 viewed in FIG. 4), which communicate with and larger than the through-holes 222.

Consequently, in assembling the contacts 230 into the connector 200, the pipe portions 231 of the contacts 230 are inserted into the through-holes 221 from the ends opposite to the reduced diameter holes 221a, and then the rear holder 220B is brought into an abutment against the front holder 220A so that the connection portions 233 of the contacts 230 completely extend through the through-holes 222, and the pipe portions 231 of the contacts 230 are embraced between shoulders of the reduced diameter holes 221 a and of the enlarged diameter holes 222a of the front and rear holders, thereby firmly holding the contacts 230 in the front and rear holders 220A and 222B. Of course, the respective portions of the through-holes of the front and rear holders 220A and 220B may have inner diameters so sized that the portions of the contacts 230 can be smoothly fitted into the corresponding portions of the through-holes.

The contact and holder subassembly thus assembled is fitted into the rear cylinder portion of the shell 210 so that the front holder 220A is brought into an abutment against a stopper 211 formed by, for example, a reduced diameter portion in the shell 210, while a fixture 171 such as a retainer ring is interposed between the cylindrical outer surface of the rear holder 220B and the inner wall of the shell 210, thereby enabling the contact holder 220 to be fixed in a simple manner. Alternatively, instead of the stopper 211, simple protrusions (not shown) serving as positioning means may be used. In this manner, the contacts 230 can be correctly supported in their predetermined positions. Wires C1 of the cable C are connected to the connection portions 233 of the contacts 230, respectively.

The front and rear holders 220A and 220B performing the above functions may be formed of an insulating material such as a resin. Different from the prior art, according to the invention the contacts 230 are fixed to the holders 220A and 220B without using press-fitting and therefore it is possible to form the holders from a rubber having a suitable hardness.

In fitting the shell 210 with its rear end in the rear shell 240, according to the invention as shown in FIG. 3 an annular sealing gasket 172 is provided between the rear end of the shell 210 and the shoulder 241 of an enlarged inner diameter portion of the rear shell 240 to provide a waterproof construction for effectively preventing any water from entering at the outer peripheries of these shells 210 and 240. Moreover, the elastic bushing 250 arranged on the outer surface of the cable C has an enlarged diameter portion 251 at its front end which abuts against the rear end of the rear shell 240 also to provide a waterproof construction for effectively preventing any water from entering from the side of the cable C.

The shell 210 and the rear shell 240 are connected to each other at their fitting portions by means of connecting means such as screws formed in their abutting surfaces. In order to ensure a more reliable connection therebetween, according to the invention set screws 173 are provided so as to be engaged with both the shells 210 and 240. However, these set screws 137 may be dispensed with, if desired.

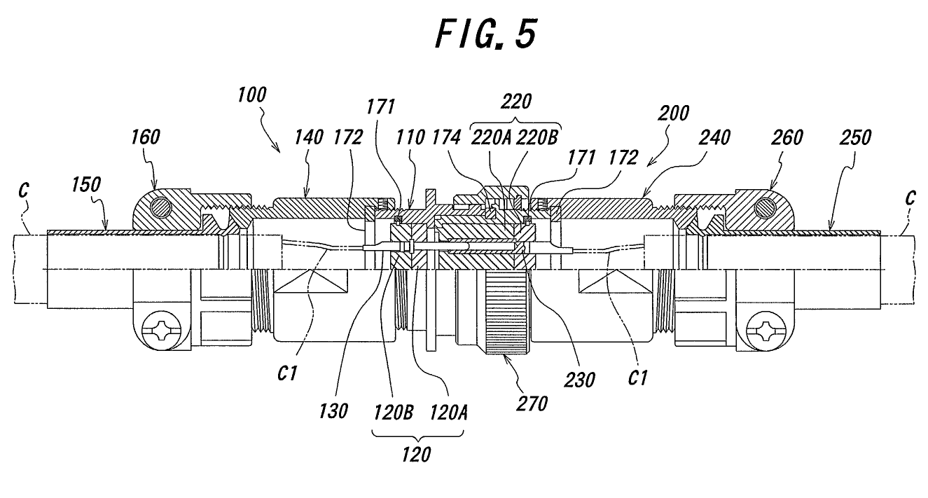

The connector 100 having the male type contacts 130 and the connector 200 having the female type contacts 230 can be connected as shown in FIG. 5, provided that the sizes and shapes of both the contacts 200 and 230 are mating with one another.

In more detail, the shell 210 of the connector 200 is inserted with its forward end into the shell 110 of the connector 100 into the innermost position so that the contact pins 132 of the male type contacts 130 in the connector 100 are inserted into the contact holes 232 of the female type contacts 230 in the connector 200, whereby the male and female type contacts are electrically connected with one another.

With these connectors 100 and 200 with their contacts thus electrically connected, the cylindrical coupling 270 of the connector 200 is actuated to be rotated so that locking means (not shown) provided on the inside of the coupling 270 is brought into engagement with further locking means (not shown) on the outside of the shell 110, thereby providing a reliable connection between the two connectors 100 and 200. If an annular sealing gasket 174 is provided in the enlarged diameter portion of the shell 210 of the connector 200 (FIG. 5), the forward end of the shell 110 of the connector 100 abuts against the sealing gasket 174 to provide a waterproof construction at this point, thereby effectively preventing any water from entering thereat.

While the connector 100 has the male type contacts 130 and the connector 200 has the female type contacts 230 in the above embodiments, the connector 100 may have female type contacts and the connector 200 may have male type contacts to perform the same functions described above.

While the invention has been particularly shown and described with reference to preferred embodiments thereof, it will be understood by those skilled in the art that the foregoing and other changes in form and details can be made therein without departing from the spirit and scope of the invention.

What is claimed is:

1. A cable connector including a cylindrical shell, a contact holder in the form of an inner bottom plate fitted in said cylindrical shell, and a plurality of contacts supported in said contact holder, wherein said contact holder comprises a front holder and a rear holder which are formed with a plurality of through-holes communicating and aligned with each other for embracing said contacts inserted in the through-holes.

2. The cable connector as set forth in claim 1, wherein said contacts are of a male type or a female type.

3. The cable connector as set forth in claim 1 or 2, wherein the cable connector comprises a cylindrical rear shell into which one end of said cylindrical shell is fitted, and an annular sealing ring provided at an abutment portion of said one end of said cylindrical shell against said cylindrical rear shell.

4. The cable connector as set forth in claim 1, wherein each of said through-holes of at least one of said front and rear holders includes at least one different diameter portion to form a shoulder, and each of said contacts includes at least one different diameter portion cooperating with said shoulder for embracing the contact inserted in the through-hole.
